(19) United States
(12) Patent Application Publication
(10) Pub. No.: US 2026/0131524 A1
(43) Pub. Date: May 14, 2026

(54) APPARATUS AND METHOD FOR CONTINUOUS PROCESSING OF CAPS

(71) Applicant: SACMI COOPERATIVA MECCANICI IMOLA SOCIETA' COOPERATIVA, IMOLA (BOLOGNA) (IT)

(72) Inventors: Marco CASADIO, Imola (BOLOGNA) (IT); Massimo BALDUCCI, Imola (BOLOGNA) (IT); Andrea FIORENTINI, Faenza (RAVENNA) (IT); Roberto MASRE', Imola (BOLOGNA) (IT)

(21) Appl. No.: 19/119,623

(22) PCT Filed: Oct. 10, 2023
(86) PCT No.: PCT/IB2023/060153

§ 371 Date: Apr. 9, 2025

(30) Foreign Application Priority Data
Oct. 12, 2022 (IT) 102022000021048

(51) Int. Cl. B29C 53/80; B29C 31/00; B29C 53/02; B29L 31/56

(52) U.S. Cl. CPC B29C 53/8041; B29C 31/008; B29C 53/02; B29C 2793/0036; B29C 2793/009; B29L 2031/565

(57) ABSTRACT

An apparatus for continuous processing of caps, wherein each cap has a side wall extending around a longitudinal axis between a first end and a second end, a transverse wall joined to the first end and a plurality of tabs projecting from the second end. The apparatus includes: a bending station including a bending carousel and a plurality of bending units, each configured to bend the plurality of tabs of the cap towards the longitudinal axis; a feed unit, configured for moving the caps along a movement path, located upstream of the bending station and for feeding the caps to the bending station, where each cap, along the movement path, adopts a predetermined orientation at a first inspection position; a pericentric camera, located along the movement path and defining an optical axis of its own, aligned with the longitudinal axis of the cap disposed at the first inspection position; a control unit, connected to the pericentric camera to drive it synchronously with the caps moving along the movement path.

### TECHNICAL FIELD

This invention relates to an apparatus for continuous processing of caps. This invention also relates to a method for continuous processing of caps.

### BACKGROUND ART

Typically, caps comprise a body and a tamper evident ring joined to each other by a connecting strip; more specifically, the tamper evident ring comprises a plurality of tabs projecting from one end of the side wall of the cap. Apparatuses of the type described herein allow bending the tabs of the side wall; thus, when the tabs are bent, the tamper evident ring remains attached to the neck of the container even when the body of the cap is separated from the neck of the container. An example of apparatuses of this kind is described in patent document WO2006138095A1.

The caps may also comprise notching (or recesses or slits) made in the side wall of the cap. Typically, the zone separating the cap body from the tamper evident ring (that is, the connecting strip) may be made with a series of notches and bridges, that is to say, breakable connecting zones joining the body to the tamper evident ring and intended to tear when the cap is twisted off for the first time. In other types of caps, for example, those known as “tethered” caps, a permanent connecting zone of the tear strip does not tear and keeps the cap body attached to the tamper evident ring, thereby reducing litter in the environment. Like traditional caps, the connecting zone of tethered caps may include a series of notches and bridges; alternatively, the connecting zone of tethered caps may be in the form of recesses, or narrow thickness portions which are less thick than the cap body and the tamper evident ring and which tear the first time the cap is twisted off of the container.

For the caps to work properly, it is important to ensure that the tabs are well made and free of defects; moreover, for both traditional caps and tethered caps, the notching or recesses must be of high quality not only to make opening the container easier for the user but also to prevent unwanted tearing before first use.

In this field, therefore, the need to inspect the caps before they are applied to the containers is felt particularly strongly.

Typically, inspection is performed after bending; that means the tabs, after being bent towards a longitudinal axis of the cap, can cover part of the inside surface of the side wall, making it difficult to detect defects in the tabs themselves or to inspect the notching or the recesses. One solution to this problem is to inspect the cap before bending the tabs. Usually, solutions of this kind involve using a dedicated inspection apparatus located downstream of the bending apparatus. Such solutions, however, are complex and increase the overall dimensions of the machine. The complexity and overall dimensions are increased if the apparatus also makes the notching.

Document EP3911483A1 describes an apparatus for processing caps comprising a cutting unit and a conveying mean defining a transport path to and from the cutting unit. The inspection of the caps is performed by a detection system that is located downstream the cutting unit to fully detect the inner walls of the cap. However, this document does not exhaustively explain how to perform the inspection. Moreover, the inspection is performed after bending, meaning that the tabs can cover part of the inside surface, making it difficult to detect defects accurately.

### DISCLOSURE OF THE INVENTION

The aim of this disclosure is to provide an apparatus and a method for continuous processing of caps to overcome the above mentioned disadvantages of the prior art.

More specifically, the aim of this disclosure is to provide an apparatus which is relatively compact and which allows caps to be inspected while they are still inside it.

A further aim of this disclosure is to provide an apparatus for inspecting caps effectively. Yet another aim of this disclosure is to provide an apparatus for inspecting notching or recesses effectively.

This aim is fully achieved by the apparatus and the method of this disclosure for continuous processing of caps, as characterized in the appended claims.

More specifically, each cap has a side wall extending around a longitudinal axis between a first end and a second end, a transverse wall joined to the first end of the side wall and a plurality of tabs projecting from the second end of the side wall. The caps may be made from plastic material.

The apparatus is configured to perform a process on the caps. The apparatus comprises a bending station.

The bending station is configured to bend the plurality of tabs of each cap towards the longitudinal axis. Preferably, the bending station includes a bending carousel which rotates about an axis of rotation.

In an example, the bending station includes a plurality of bending units, each configured to bend the plurality of tabs of the cap towards the longitudinal axis. The bending units are mounted on the bending carousel. The plurality of bending units may be configured to bend the plurality of tabs of a corresponding plurality of caps towards the longitudinal axis simultaneously. Alternatively, the plurality of bending units may be configured to bend the plurality of tabs of a corresponding plurality of caps towards the longitudinal axis in succession. Preferably, each bending unit is mounted on the bending carousel around the axis of rotation of the bending carousel.

The apparatus comprises a feed unit, configured for moving the caps, for example, along a movement path.

Preferably, the movement path is located upstream of the bending station. The feed unit is configured for feeding the caps to the bending station. The feed unit can feed a plurality of caps to the bending station simultaneously or in succession.

Preferably, each cap, along the movement path, adopts a predetermined orientation at a first inspection position.

The apparatus comprises a first camera, located along the movement path and defining an optical axis of its own. Preferably, the optical axis of the first camera is aligned with the longitudinal axis of the cap at the first inspection position.

The first camera is configured to view an outside surface of the side wall of the cap. The first camera is configured to capture a whole outside surface of the side wall of the cap.

Preferably, the first camera is a pericentric camera. The camera may include a biconvex lens or a Fresnel lens. The first camera may be configured to view an outside surface of the first end of the side wall around the longitudinal axis, and/or an outside surface of the second end of the side wall around the longitudinal axis.

The apparatus comprises a control unit, connected to the first camera (or to the pericentric camera). Preferably, the control unit drives the first camera synchronously with the caps moving along the movement path. The control unit may be configured to receive from the first camera image data captured by the first camera and representing the side wall of the cap at the first inspection position.

The pericentric camera has the advantage of capturing the whole side wall of the cap to be able to view details of it irrespective of the orientation of the cap (that is, irrespective of which direction it faces) along the movement path. The apparatus thus made allows inspecting the side wall of the cap and, in particular, the tabs, before the tabs are bent towards the longitudinal axis.

In an example embodiment, the apparatus comprises an inlet, configured to receive an ordered succession of caps. The inlet may be connected to the feed unit. The feed unit may be configured to receive the ordered succession of caps from the inlet.

In an example embodiment, each cap, along the movement path, adopts a predetermined orientation at a second inspection position. The apparatus may comprise a second camera. The second camera may be a pinhole camera or a wide-angle camera. The second camera (that is, the pinhole camera or the wide-angle camera) is preferably located along the movement path and defines an optical axis of its own. The optical axis of the second camera is preferably aligned with the longitudinal axis of the cap at the second inspection position, to axially view an inside surface of the side wall of the cap.

Preferably, the second camera is a pinhole camera. This has the advantage of having a large aperture angle (that is, approximately 90°). Another advantage of the pinhole camera is that a portion of it facing the cap to be inspected has a small diameter (for example, smaller than a corresponding wide-angle camera) and this allows greater freedom in positioning it, making it possible to view small objects such as caps.

In an example, the second inspection position may be intended for receiving caps provided with notching or a recess or a narrow thickness wall on its side wall.

In this document, the term notching is used to mean a notch or series of notches; this invention may, however, also be applied to caps having a slit (or slits) and/or narrow thickness walls.

In an embodiment, the apparatus comprises a third inspection position, where the caps adopt a predetermined orientation. Preferably, the third inspection position is intended for receiving caps provided with notching on their side walls.

For example, the apparatus comprises a plurality of side cameras, defining a respective plurality of optical axes oriented radially with respect to the longitudinal axis of the cap at the third inspection position, so as to view the outside surface of the side wall of the cap.

Preferably, the control unit is connected to the pinhole camera and to the plurality of side cameras to receive respective image data and is programmed to process the image data in order to derive information regarding the notching of the side wall of each cap.

In an example, the control unit is programmed to derive a developed image from the image data received from the plurality of side cameras, where the developed image shows the side wall of the cap represented in a plane.

In an example, the apparatus comprises a fourth inspection position, where the caps adopt a predetermined orientation. Preferably, the fourth inspection position is intended for receiving caps having characters moulded on the inside surface and/or the outside surface of the transverse wall. The apparatus may comprise a recognition camera, defining an optical axis of its own, preferably aligned with the longitudinal axis of the cap disposed at the fourth inspection position, to image the characters moulded on the inside surface and/or the outside surface of the transverse wall of the cap.

The apparatus may comprise a rejection device, located downstream of the recognition camera with respect to a feed path of the caps. The control unit is connected to the recognition camera to receive image data. The control unit may be programmed to process the image data to derive information regarding the characters moulded on the inside surface of the transverse wall of the cap, thus defining an OCR system.

The control unit may be programmed to drive the rejection device so as to separate one or more caps from the flow of caps in transit through the fourth inspection position based on the derived information regarding the moulded characters. Separation by the rejection device may occur downstream or upstream of the recognition camera (thus defining a feedback system). The moulded characters may represent a cavity of a mould in which the cap has been made. Thus, separation by the rejection device may occur on the basis of the cavity in which the cap was made.

In an example, the feed unit comprises a transfer element, positioned upstream of the bending station. Preferably, the transfer element comprises a transfer carousel. The transfer carousel is configured to move the cap along at least one portion of the movement path in order to load the caps individually onto the bending carousel of the bending station.

Preferably, the first inspection position is located in said at least one portion of the movement path. Preferably, the pericentric camera is stationary relative to the transfer carousel.

In an example, the second inspection position is located in said at least one portion of the movement path. Thus, the side wall of the cap, preferably notching on the side wall of the cap, can be inspected before the tabs are bent inwards, thus preventing them from blocking the field of vision between the camera and the side wall of the cap or notching on the side wall of the cap. Preferably, the second camera (that is, the pinhole or wide-angle camera) is stationary relative to the transfer carousel.

The fact that the pericentric camera is located at the transfer carousel, upstream of the bending carousel, makes the apparatus compact.

In an example, the apparatus comprises a slide plate, interacting with the transfer carousel to slidably support the caps moved by the transfer carousel.

In an embodiment, the slide plate includes a black, opaque portion and the pericentric camera is directed at the black, opaque portion of the slide plate. In an embodiment, the slide plate includes an additional black, opaque portion and the pinhole camera is directed at that black, opaque portion of the slide plate. The black, opaque portion has the advantage of providing a good contrast for the image captured by the pericentric camera and/or by the pinhole or wide-angle camera.

In an embodiment, each cap, along the movement path, adopts a predetermined orientation at a fifth inspection position. The apparatus may comprise a fixed focal length camera, located along the movement path and defining an optical axis of its own, aligned with the longitudinal axis of the cap, preferably at the fifth inspection position, to view an outside surface and/or an inside surface of the transverse wall of the cap.

Preferably, the fifth inspection position is located in the aforesaid at least one portion of the movement path.

In an example, the transfer carousel includes a first face and a second face, opposite the first face, the pericentric camera being directed towards the first face and the fixed focal length camera being directed towards the second face. In an embodiment, the slide plate includes a transparent portion and the fifth camera is directed at the transparent portion of the slide plate. That way, it is possible to inspect an outside surface of the transverse wall of the cap.

In an example, the pinhole camera is stationary relative to the transfer carousel. The pericentric camera and the pinhole camera may both be directed at the first face.

The pericentric camera, the pinhole camera and the fixed focal length camera allow inspecting the whole cap, that is to say, they allow inspecting both an inside surface and an outside surface of the side wall and of the transverse wall of the cap.

In an embodiment, the apparatus comprises a cutting station. Preferably, the cutting station includes a cutting carousel that rotates about an axis of rotation and is adapted to receive a plurality of cutting units configured to make notching on the side wall of the cap. Preferably, the transfer carousel is located between the cutting carousel and the bending carousel and is configured to receive the caps from the cutting carousel, so that a part of the movement path is defined by the movement of the cutting carousel.

It is noted that in an embodiment, the cutting station is configured to receive a plurality of cutting units, each adapted to make notching on the side wall of a cap; in this case, the cutting station is adapted to cut the notching and to move the caps along a part of the movement path defined by the movement of the cutting carousel. In an embodiment, the cutting station is configured to receive the plurality of cutting units but does not cut the notching in the caps; in this other case, the cutting station does not make any cuts and thus the cutting station is configured to move the caps along a part of the movement path defined by the movement of the cutting carouse without cutting the notching. This gives the apparatus the advantage of modularity, making it suitable both for cutting the notching inside the apparatus and for receiving caps on which the notching has already been made, directly in the mould, for example.

In an example, the apparatus comprises an outfeed conveyor. The outfeed conveyor may be configured to receive the caps from the bending station. The outfeed conveyor may be configured to move the caps along an outfeed path, preferably located downstream of the bending station. The apparatus may comprise an outlet for feeding the processed caps out from the apparatus. The apparatus may comprise a third inspection position according to one or more features of this disclosure and a plurality of cameras according to one or more features of this disclosure; the third inspection position may be situated along the outfeed path.

In an example, the apparatus comprises a fourth inspection position and a recognition camera according to one or more aspects of this disclosure and the fourth inspection position may be situated along the outfeed path. In an embodiment, the feed unit includes an infeed conveyor belt, configured to transport the caps individually in succession, along an infeed path towards the bending station or, when present, towards the cutting station. Preferably, the infeed path forms part of the movement path. The pericentric camera and/or the pinhole camera, the plurality of side cameras and/or the recognition camera may be located along the infeed path.

Preferably, in the embodiments provided with the transfer carousel, the infeed conveyor belt is located upstream of the transfer carousel. In the embodiments provided with the cutting station (that is, the cutting carousel), the infeed conveyor belt is located upstream of the cutting carousel. The cutting carousel may be located between the infeed conveyor belt and the transfer carousel. The infeed conveyor belt may therefore be configured to feed the cutting carousel with a succession of caps.

In an example, the control unit is programmed to process image data captured by the pericentric camera and to compare them with reference data representing a correct positioning of the plurality of tabs in order to derive information regarding an alert signal responsive to a negative result of the comparison.

This disclosure teaches how a cap, before the tabs on the cap are bent, can be effectively inspected by means of an inspection system comprising a pericentric camera, located upstream of the bending station and configured to inspect an outside surface of the side wall of the cap. Preferably, the pericentric camera defines an optical axis that is aligned with the longitudinal axis to view the cap from above. The inspection system may comprise a pinhole camera, located upstream of the bending station and configured to inspect an inside surface of the side wall of the cap. Preferably, the pinhole camera defines an optical axis that is aligned with the longitudinal axis to view the cap from above (relative to a direction defined by the weight force). The inspection system may comprise a fixed focal length camera, located upstream of the bending station and configured to inspect an outside surface of the transverse wall of the cap. Preferably, the fixed focal length camera defines an optical axis that is aligned with the longitudinal axis to view the cap from below. The system may comprise a plurality of side cameras, located upstream or downstream of the bending station and configured to inspect an outside surface of the transverse wall of the cap, specifically to inspect notching on an outside surface of the transverse wall. Preferably, the plurality of side cameras defines a corresponding plurality of optical axes oriented transversely to the longitudinal axis to view the cap from the side (that is, transversely to the longitudinal axis).

This disclosure also provides a method for continuous processing of caps. The method comprises a step of bending the plurality of tabs towards the longitudinal axis by means of a bending station according to one or more aspects of this disclosure.

The method comprises a step, performed by a feed unit, of moving the caps along a movement path according to one or more aspects of this disclosure.

The method comprises a step of feeding the caps to the bending station, carried out, for example, by the feed unit.

The method comprises a step, carried out by a first camera, of capturing image data, where the first camera is according to one or more aspects of this disclosure.

Preferably, the method comprises a step of capturing image data, carried out by a pericentric camera, located along the movement path and defining an optical axis of its own, aligned with the longitudinal axis of the cap when the cap is at the first inspection position.

The method comprises a step, carried out by a control unit, of driving the pericentric camera synchronously with the caps moving along the movement path.

In an example, the method comprises a step of capturing image data, carried out by a second camera.

Preferably, the method comprises a step of capturing image data, carried out by a pinhole camera, located along the movement path and defining an optical axis of its own, aligned with the longitudinal axis of the cap when the cap is at the second inspection position, where the cap, at the second inspection position, adopts a predetermined orientation.

The method may comprise a step of receiving, at a third inspection position, a flow of caps provided with notching on their side walls, where the caps, at the third inspection position, adopt a predetermined orientation. The method may comprise a step of capturing image data, carried out by a plurality of side cameras, defining a respective plurality of optical axes oriented radially with respect to the longitudinal axis of the cap when the cap is at the third inspection position, so as to view the outside surface of the side wall of the cap. The method may comprise a step, carried out by the control unit, of receiving the image data from the pinhole camera and/or the image data from the plurality of side cameras, and processing the image data received in order to derive information regarding the notching on the side wall of each cap.

In an example, the feed unit includes a transfer carousel, made according to one or more aspects of this disclosure. Preferably, the transfer carousel is located upstream of the bending station. The method may comprise a step, performed by the transfer carousel, of moving the caps along at least one portion of the movement path. The method may comprise a step, performed by the transfer carousel, of loading the caps individually onto the bending carousel of the bending station. In an example, the first inspection position is located in said at least one portion of the movement path. The pericentric camera may be stationary relative to the transfer carousel.

In an embodiment, the method comprises a step of providing a second inspection position along the movement path, the caps adopting a predetermined orientation at the second inspection position; the method may comprise a step of providing a pinhole camera defining an optical axis of its own, aligned with the longitudinal axis of the cap when the cap is at the second inspection position. The method comprises a step of providing a fifth inspection position along the movement path, the caps adopting a predetermined orientation at the fifth inspection position, and a step, carried out along the movement path, of providing a fixed focal length camera defining an optical axis of its own, aligned with the longitudinal axis of the cap when the cap is at the fifth inspection position. The second and/or the fifth inspection position may be situated in the aforesaid at least one portion of the movement path defined by the transfer carousel.

### BRIEF DESCRIPTION OF DRAWINGS

These and other features will become more apparent from the following description of a preferred embodiment, illustrated by way of non-limiting example in the accompanying drawings, in which:

FIGS. 1A-1D illustrate the apparatus for processing caps according to one or more aspects of this disclosure;

FIG. 2 illustrates a portion of the apparatus for processing caps according to one or more aspects of this disclosure;

FIGS. 3A-3C illustrate a portion of the apparatus for processing caps according to one or more aspects of this disclosure;

FIGS. 4, 5A-5B, 6A and 6B illustrate different example embodiments of the processing apparatus according to one or more aspects of this disclosure;

FIG. 7A shows a cross section of a cap having plurality of tabs that have not been bent;

FIG. 7B shows a cross section of a cap having plurality of tabs that have been bent towards the longitudinal axis.

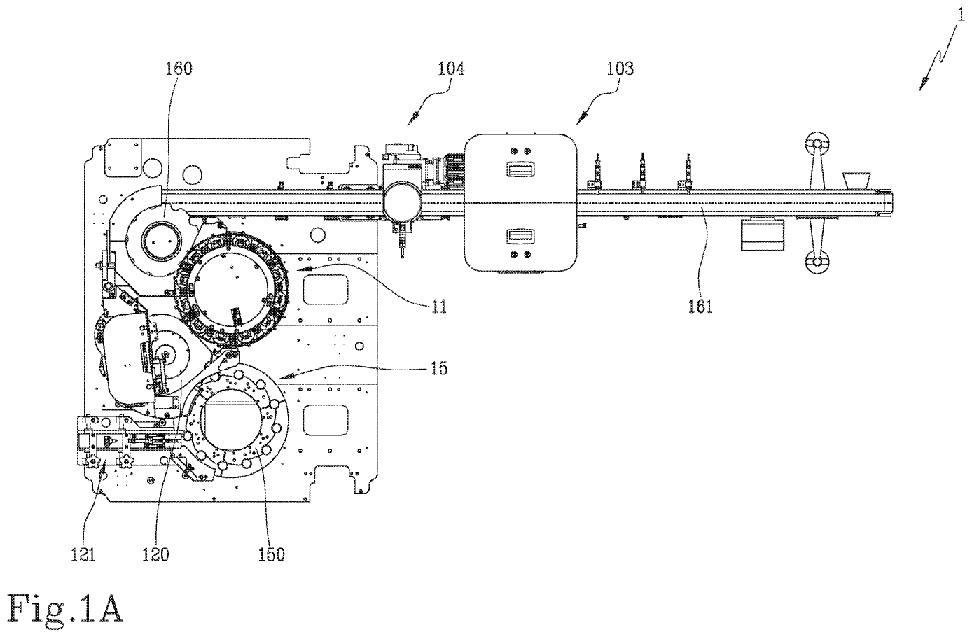

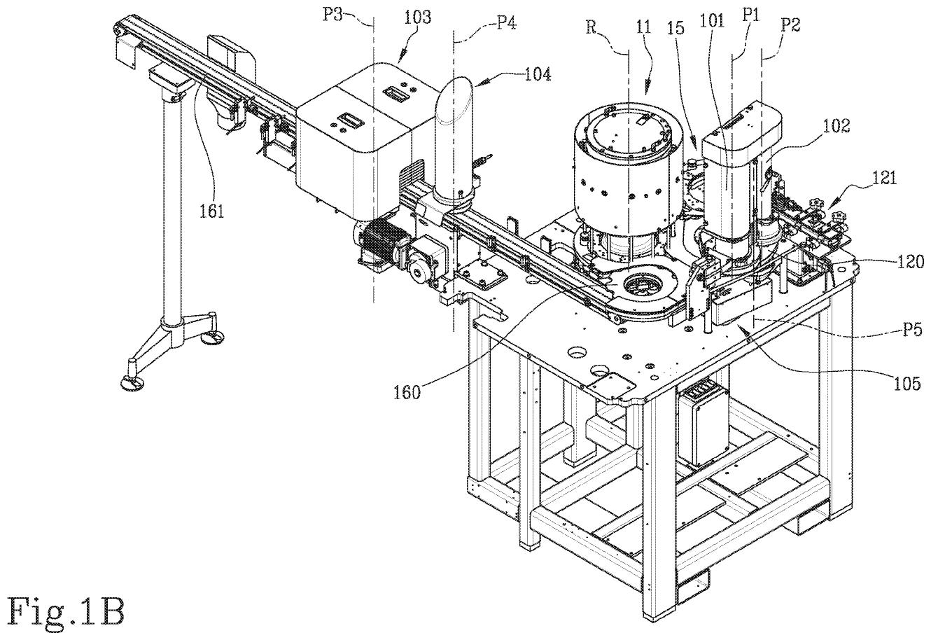

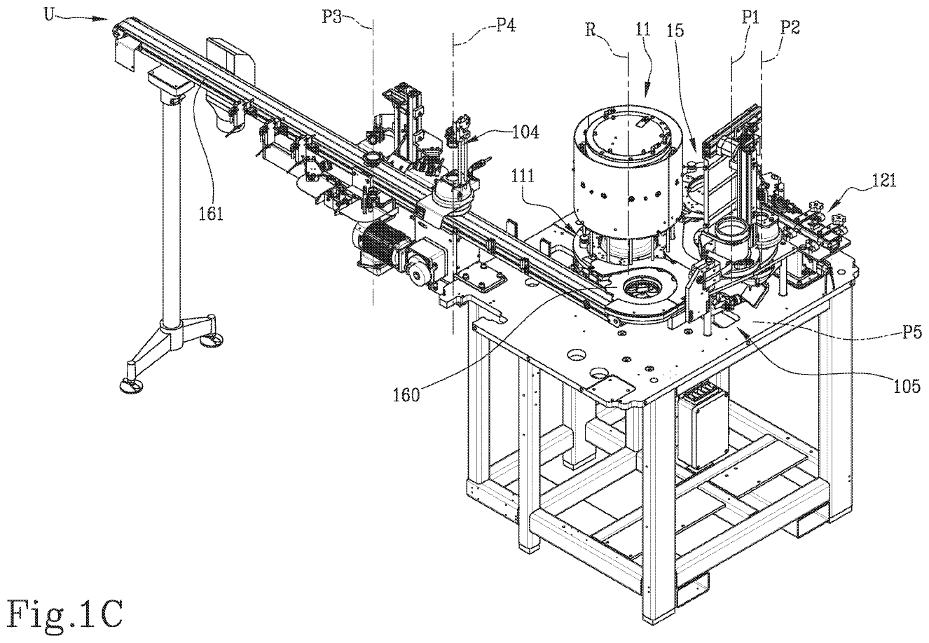

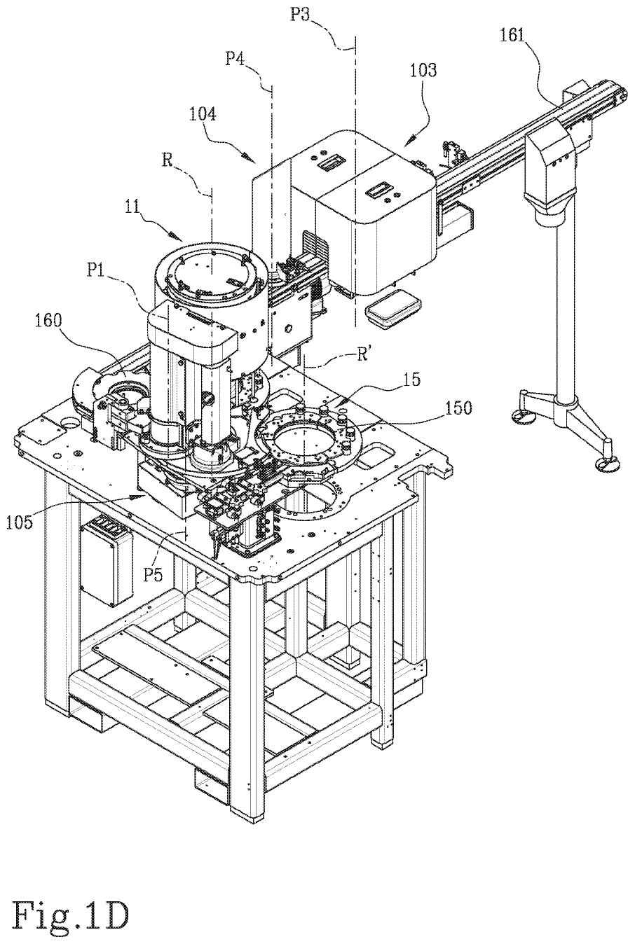

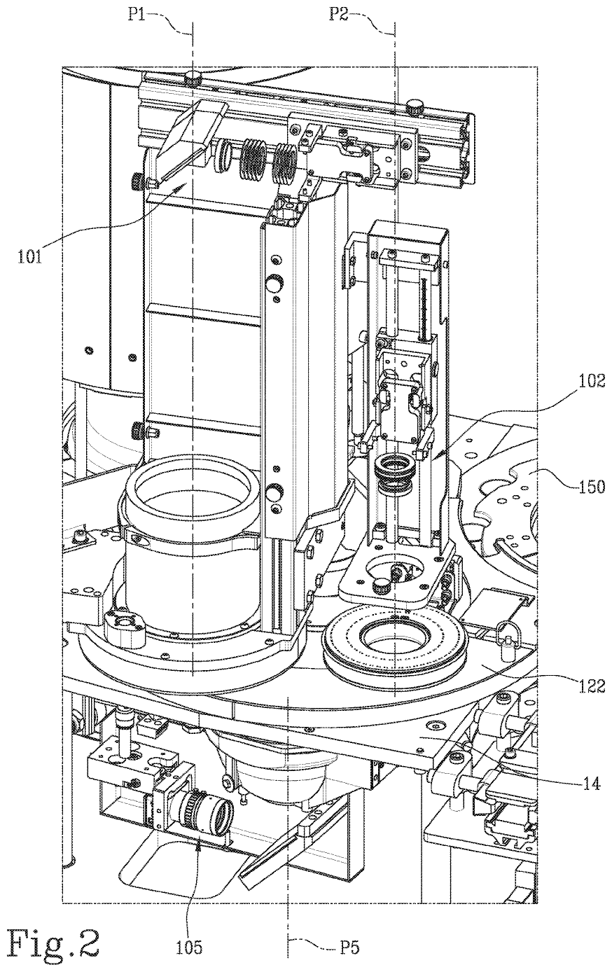

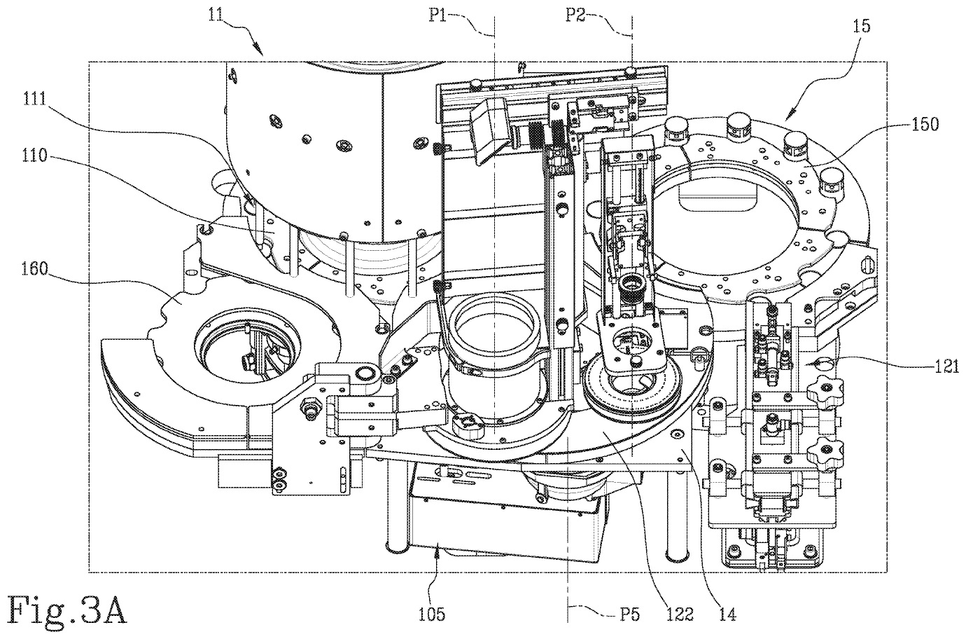

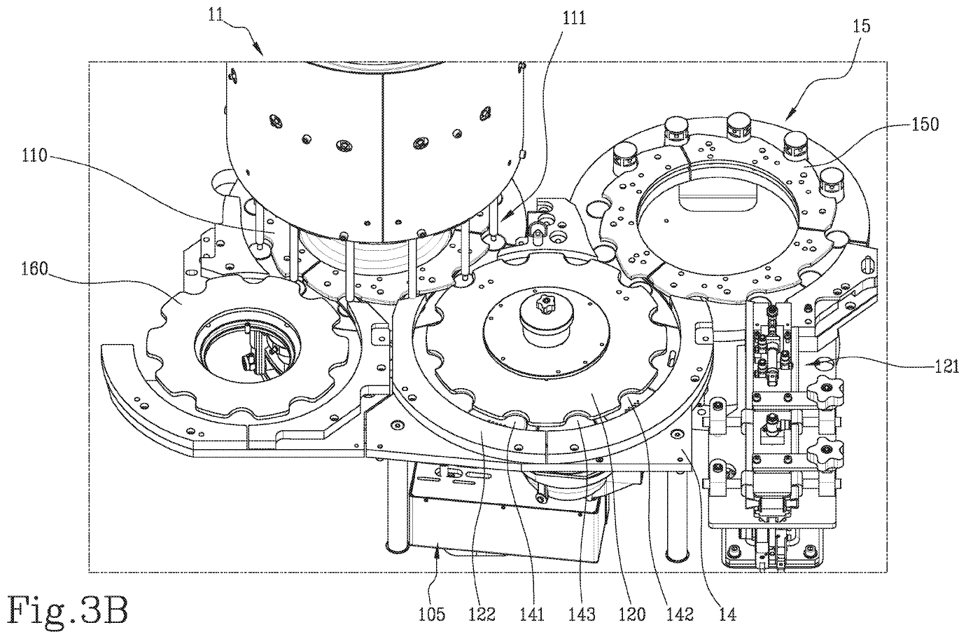

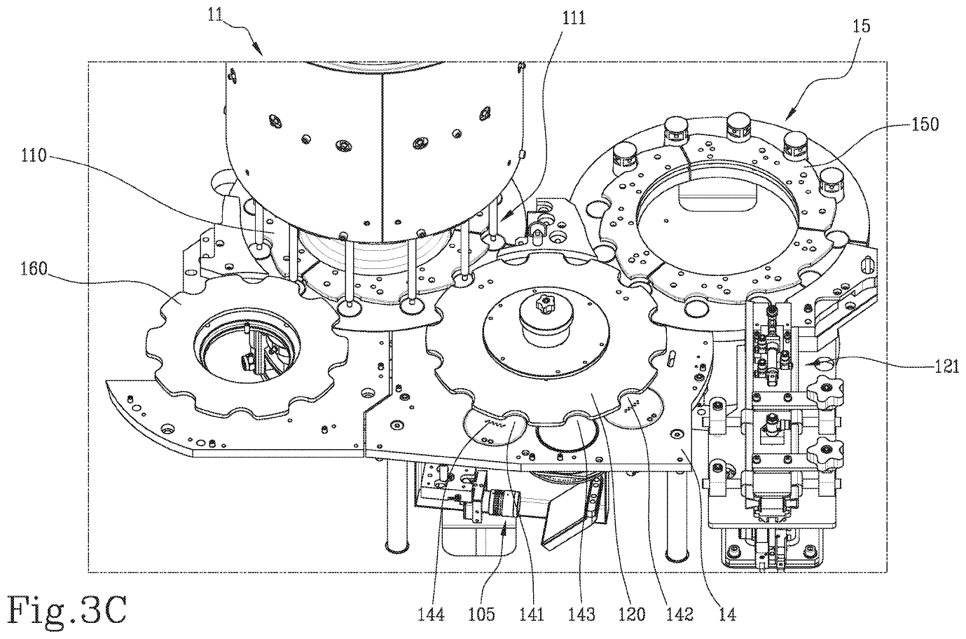

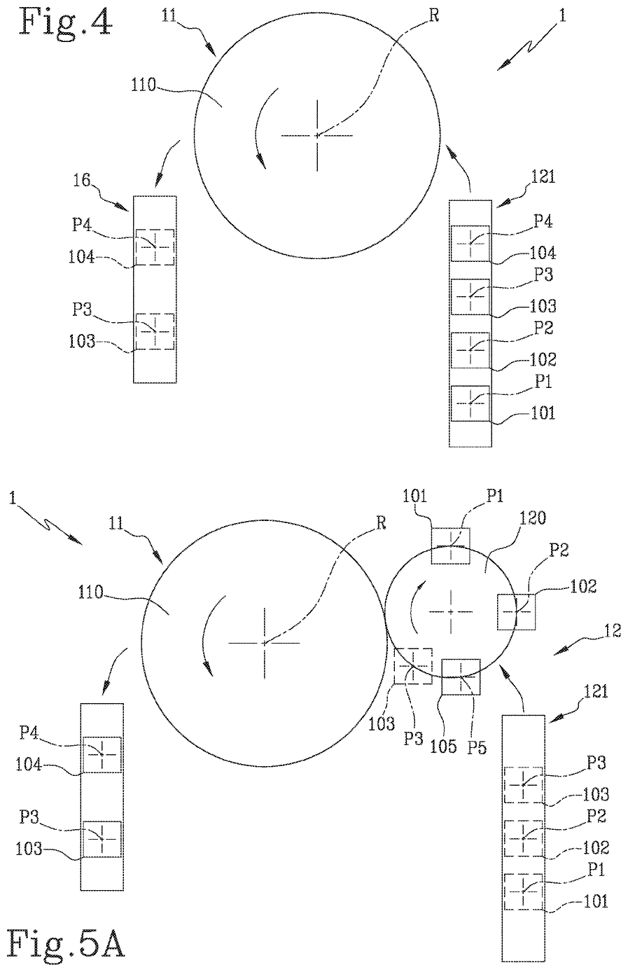

### DETAILED DESCRIPTION OF PREFERRED EMBODIMENTS OF THE INVENTION

The numeral 1 in the drawings denotes an apparatus for continuous processing of caps 2. The cap 2 comprises a side wall 21, extending around a longitudinal axis L between a first end 211 and a second end 212. The cap 2 comprises a transverse wall 22 joined to the first end 211 of the side wall 21. The cap 2 comprises a plurality of tabs 23 projecting from the second end 212 of the side wall 21.

The cap 2 may also comprise notching or a narrow thickness portion, made on the side wall 21 of the cap. The cap 2 may comprise characters moulded on an inside surface of the transverse wall 22 of the cap 2.

The apparatus 1 comprises a bending station 11. The bending station 11 includes a bending carousel 110 which rotates about an axis of rotation R. The bending station 11 comprises a plurality of bending units 111 disposed on the bending carousel 110 equidistantly from each other around the axis of rotation R. Each bending unit 111 is configured to bend the plurality of tabs 23 of the cap 2 in such a way that the bending station 11 is configured to bend the tabs 23 of a plurality of caps 2 in a continuous cycle.

Preferably, the apparatus 1 comprises a cutting station 15 including a cutting carousel 150 which rotates about an axis of rotation R'. The cutting carousel 150 may be configured to receive a plurality of cutting units adapted to cut notching on the side wall 21 of the cap 2 so that the cutting station 15 is configured to cut notching on the side wall 21 of the cap 2 in a continuous cycle. Alternatively, the notching may be carried out upstream of the apparatus 1, for example, in a mould for forming the caps 2.

The apparatus 1 comprises a feed unit 12. The feed unit 12 is configured to move the caps 2 in succession along a movement path. The feed unit 12 is configured to receive the caps 2 in succession from the cutting carousel 150 and to feed the caps 2 in succession to the bending carousel 110. More specifically, the feed unit 12 comprises a transfer carousel 120, located upstream of the bending carousel 110 and rotating about an axis of rotation T, preferably parallel to the axis of rotation R of the bending carousel 110 and parallel to the axis of rotation R′ of the cutting carousel 150. The transfer carousel 120 is configured to receive the caps 2 from the cutting carousel 150 and to feed the caps 2 to the bending carousel 110. Therefore, the transfer carousel 120 is located between the cutting carousel 150 and the bending carousel 110.

The feed unit 12 comprises an infeed conveyor belt 121, located upstream of the cutting station 15 and configured to feed the cutting station 15 (that is, the cutting carousel 150) with the caps 2 in succession.

The apparatus 1 comprises an outfeed conveyor 16, located downstream of the bending station 12 and configured to receive the bent caps 2 in succession from the bending station 12 and to feed the caps 2 out from the apparatus 1. The outfeed conveyor 16 preferably includes an outfeed carousel 160 configured to receive the bent caps 2 from the bending carousel 110 and comprises an outfeed conveyor belt 161, located downstream of the outfeed carousel 160 to receive the caps 2 and transport them towards an outlet of the apparatus 1.

Thus, inside the apparatus 1, each cap 2 is transported along a movement path of the caps 2 from an inlet I to an outlet U of the apparatus 1. More specifically, the path of the caps 2 is defined by the movement of the infeed conveyor belt 121, the movement of the cutting carousel 150, the movement of the transfer carousel 120, the movement of the bending carousel 110, the movement of the outfeed carousel 160 and the movement of the outfeed conveyor belt 161.

The movement path of the caps 2 therefore comprises an infeed path, defined by the infeed conveyor belt 121, a cutting path, defined by the cutting carousel 150, a movement path portion or transfer path, defined by the transfer carousel 120, an outfeed path portion defined by the outfeed carousel 160 and by the outfeed conveyor belt 161.

The movement path of the caps 2 comprises at least a first inspection position P1; more specifically, the movement path of the caps comprises a plurality of inspection positions, including a second inspection position P2, a third inspection position P3, a fourth inspection position P4 and a fifth inspection position P5. Preferably, at the first inspection position P1, second inspection position P2, third inspection position P3, fourth inspection position P4 and fifth inspection position P5, the cap 2 adopts a predetermined orientation, preferably with its longitudinal axis L oriented perpendicularly to the movement path, and with an outside surface of its transverse wall 22 directed downwardly with respect to a direction defined by the weight force.

The apparatus 1 comprises a plurality of cameras. More specifically, the apparatus 1 comprises a pericentric camera 101. The pericentric camera 101 is located along the movement path, specifically along the movement path portion (or transfer path), defined by the transfer carousel 120. The pericentric camera 101 is configured to image an outside surface of the side wall 21 of the cap 2. The pericentric camera 101 defines an optical axis of its own, aligned with the longitudinal axis L of the cap 2 when the cap 2 is disposed at the first inspection position P1. The first inspection position P1, therefore, is situated along the transfer path, on the transfer carousel 120. More specifically, the transfer carousel 120 comprises a first face 120A and a second face 120B, opposite the first face 120A, and the optical axis of the pericentric camera is directed towards the first face 120A of the transfer carousel 120.

The apparatus 1 comprises a pinhole camera 102, located along the movement path, specifically along the transfer path. The pinhole camera is configured to image an inside surface of the side wall 21 of the cap 2. The pinhole camera 102 defines an optical axis of its own, aligned with the longitudinal axis L of the cap 2 when the cap 2 is disposed at the second inspection position P2. The optical axis of the pinhole camera is directed towards the first face 120A of the transfer carousel 120.

The apparatus 1 comprises a fixed focal length camera 105, located along the transfer path. The fixed focal length camera 105 is configured to image an outside surface of the transverse wall 22 of the cap 2. The fixed focal length camera 105 defines an optical axis of its own, aligned with the longitudinal axis L of the cap 2 when the cap 2 is disposed at the fifth inspection position P5. The optical axis of the fixed focal length camera 105 is directed towards the second face 120B of the transfer carousel 120, to image the outside surface of the transverse wall 22 of the cap 2.

The apparatus 1 comprises a slide plate 14, interacting with the transfer carousel 120 to slidably support the caps 2 moved by the transfer carousel 120. At the first inspection zone P1, the slide plate 14 includes a black, opaque portion 141 and the pericentric camera 101 (that is, the optical axis defined by the pericentric camera 101) is directed at the black, opaque portion 141 of the slide plate 14. At the second inspection zone P2, the slide plate 14 includes an additional black, opaque portion 142 and the pinhole camera 102 (that is, the optical axis defined by the pinhole camera 102) is directed at the additional black, opaque portion 142 of the slide plate 14. At the fifth inspection zone P5, the slide plate 14 includes a transparent portion 143 and the fixed focal length camera 105 (that is, the optical axis defined by the fixed focal length camera 105) is directed at the transparent portion 143 of the slide plate 14.

The apparatus 1 comprises a plurality of side cameras 103, located along the outfeed path, at the outfeed conveyor belt 161. The plurality of side cameras 103 defines a plurality of optical axes oriented radially with respect to the longitudinal axis L of the cap 2 when the cap 2 is at the third inspection position P3 to image an outside surface of the side wall 21 of the cap 2. Preferably, the plurality of side cameras 103 is configured to view notching or a narrow thickness portion, made on the side wall 21 of the cap 2. More specifically, the control unit processes a developed image from the image data received from the plurality of side cameras 103, where the side wall 21 of the cap 2 is represented in a plane.

The apparatus 1 comprises a recognition camera 104, located along the outfeed path, at the outfeed conveyor belt 161. The recognition camera 104 defines an axis of its own, aligned with the longitudinal axis L of the cap 2 when the cap 2 is at the fourth inspection position, to image characters moulded on an inside surface of the transverse wall 22 of the cap 2.

The apparatus 1 comprises a control unit, programmed to drive the pericentric camera 101, the pinhole camera 102, the plurality of side cameras 103, the recognition camera 104 and the fixed focal length camera 105 synchronously with the passage of the caps 2 through the first inspection position P1, the second inspection position P2, the third inspection position, P3, the fourth inspection position P4 and the fifth inspection position P5. The pericentric camera 101, the pinhole camera 102, the plurality of side cameras 103, the recognition camera 104 and the fixed focal length camera 105 define a plurality of cameras, each configured capture image data and to transmit the image data to the control unit.

In an example, the control unit receives image data from the pinhole camera 102 and from the plurality of side cameras 103 to derive information about notching made on the side wall 21 of the cap 2.

The apparatus may comprise a rejection device 13, located downstream of the recognition camera 104 on the outfeed conveyor belt 161D. The control unit receives image data from the recognition camera 104 and processes the data to derive information about the characters moulded on the inside surface of the transverse wall 22 of the cap 2. Preferably, the control unit drives the rejection device 13 to separate one or more caps from the flow of caps in transit through the fourth inspection position P4 based on the derived information regarding the moulded characters.

In an example, the infeed conveyor belt 121 and the outfeed conveyor belt 161 comprise a black, opaque surface which the transverse walls 22 of the caps 2 rest on as they move along the path.

In an example, the transfer carousel 120 comprises a guiding crown wheel 122, configured to abut against a portion of the outside surface of the side wall of the caps 2 as they are transported on the transfer carousel 120. Alternatively or in addition, the slide plate 14 may comprise air suction holes 144, for example, at the black, opaque portions 141, 142 and/or at the transparent portion 143, to hold the caps 2 in place on the transfer carousel 120 along the path.

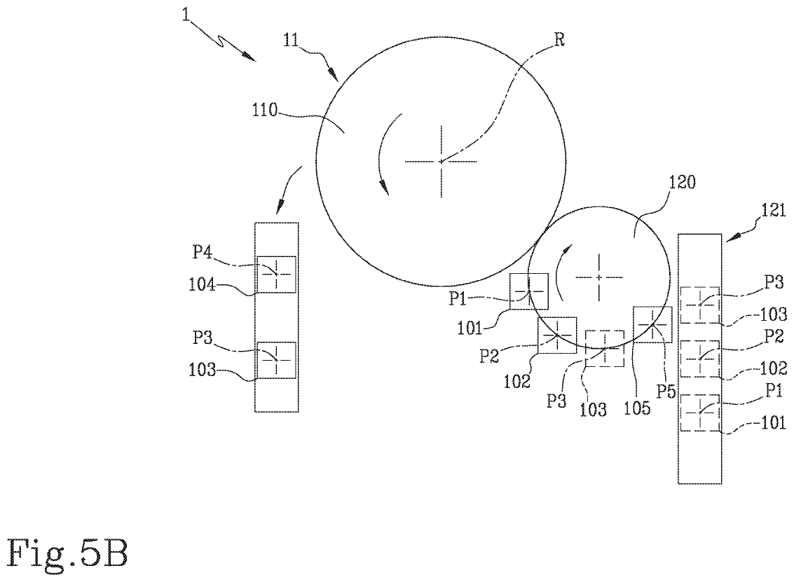

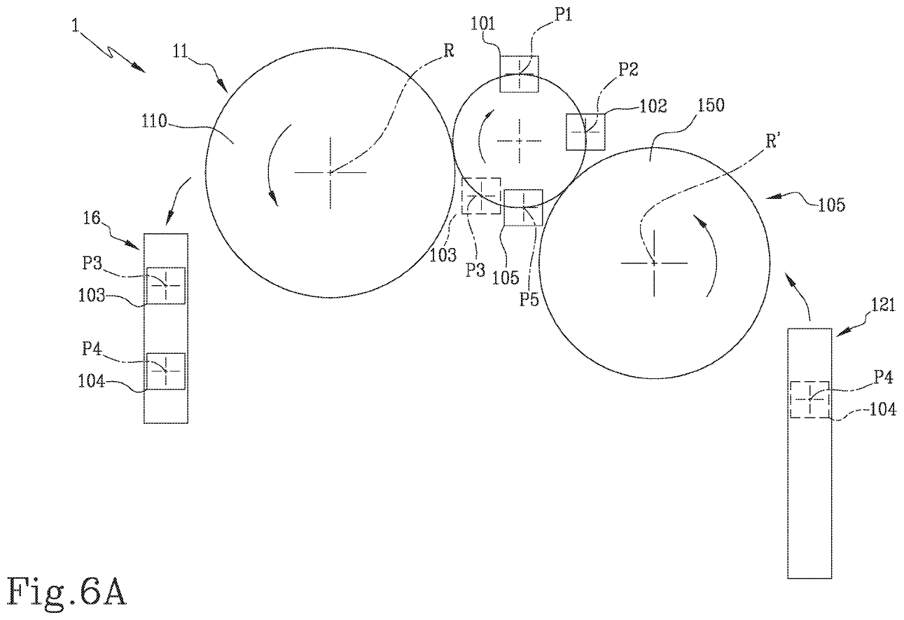

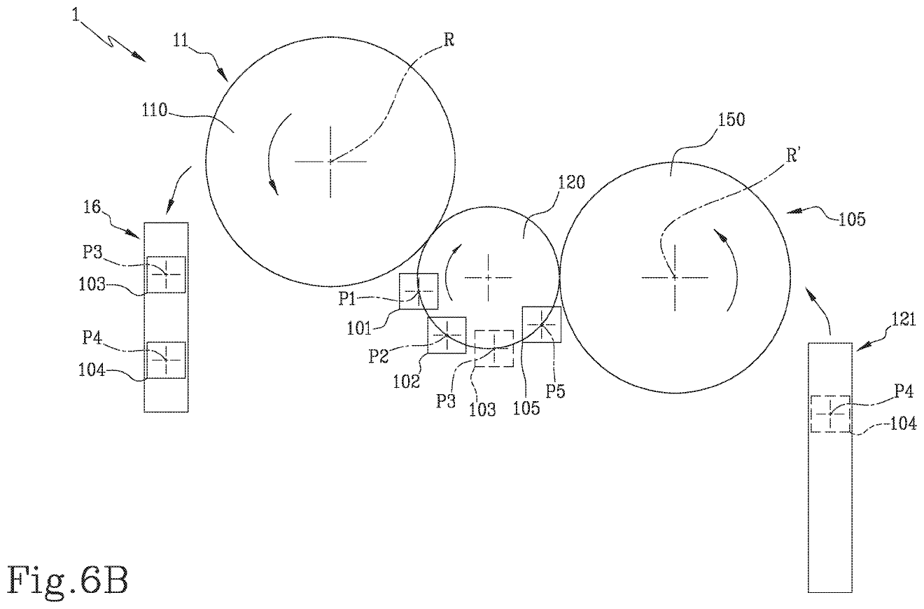

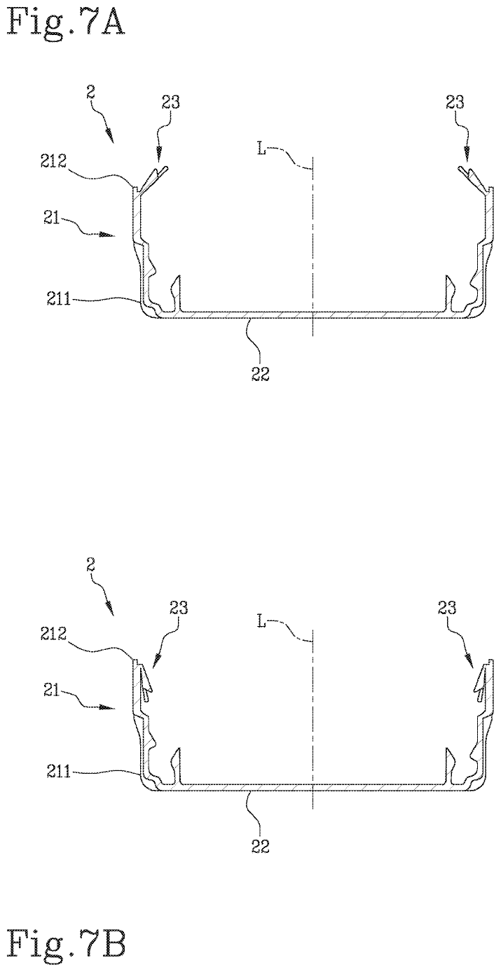

FIGS. 5B and 6B illustrate by a way of example a layout of the apparatus 1, wherein one or more of the pericentric camera 101, the pinhole camera 102, the plurality of side cameras 103 and the fixed focal length camera 105 are located in the transfer carousel 120. In particular, the pericentric camera 101, the pinhole camera 102, the plurality of side cameras 103 and the fixed focal length camera 105 are located in the transfer carousel 120. In an example, the transfer carousel 120 can be configured for receiving the caps 2 from the infeed conveyor belt 121, so that the caps 2 are inspected by one or more (or all) of the pericentric camera 101, the pinhole camera 102, the plurality of side cameras 103 and the fixed focal length camera 105; in an example, the transfer carousel 120 can be configured for receiving the caps 2 from a cutting carousel 150, so that the caps 2 are inspected by one or more (or all) of the pericentric camera 101, the pinhole camera 102, the plurality of side cameras 103 and the fixed focal length camera 105.

In an example, a straight line joining the axis of rotation R of the bending carousel 110 with the axis of rotation R′ of the cutting carousel 150 divides plane in an upper half-plane and in a lower half-plane. Preferably, when one or more (or all) the pericentric camera 101, the pinhole camera 102, the plurality of side cameras 103 and the fixed focal length camera 105 are located in the transfer carousel 120, the one or more (or all) the pericentric camera 101, the pinhole camera 102, the plurality of side cameras 103 and the fixed focal length camera 105 are located in the same half-plane (that is the lower half-plane or the upper half-plane). The axis of rotation of the transfer carousel 120 can be located in the upper half-plane or in the lower-half plane. In particular, the axis of rotation of the transfer carousel 120 is located in the same half-plane of the cameras (that is the one or more or all of the pericentric camera 101, the pinhole camera 102, the plurality of side cameras 103 and the fixed focal length camera 105) and/or of the infeed conveyor belt 121. The cameras can be located on the same half-plane of the infeed conveyor belt 121.

In an operating sequence of the apparatus 1, the inlet I of the apparatus 1 receives a succession of caps 2. The infeed conveyor belt 121 transports the caps 2 from the inlet I of the apparatus 1 to the cutting carousel 150 along an infeed path which is, preferably, substantially rectilinear. The cutting carousel 150 receives the sequence of caps 2 and transports them along the cutting path defined by the movement of the cutting carousel 150. In addition, the cutting station 15 may cut the notching on the side walls 21 of the caps 2, or the cutting station 15 may receive caps which are already provided with the notching. The cutting carousel 150 then transfers the caps to the transfer carousel 120, which transports them along the transfer path; on the transfer path, defined by the movement of the transfer carousel 120, the pinhole camera 102 captures image data representing the inside surface of the side wall 21 of the cap 2, when the cap is at the second inspection position P2. On the transfer path, the fixed focal length camera 105 captures image data representing the outside surface of the transverse wall 22 of the cap when the cap is at the fifth inspection position P5. Again on the transfer path, the pericentric camera 101 captures image data representing the outside surface of the side wall 21 of the cap 2 when the cap 2 is at the first inspection position P2.

Next, the transfer carousel 120 transfers the caps 2 onto the bending carousel 110. The bending carousel 110 receives the caps 2 in succession. Each bending unit 111 of the bending station 11 bends the tabs 23 of a cap 2. More specifically, each bending unit 111 comprises a support, configured to supportably receive an outside surface of the transverse wall 22 of the cap 2, and a plunger configured to be inserted into the cap 2 to hold the cap 2 in place on the support while the tabs 23 are being bent. The support and the plunger are movable relative to each other along a direction of movement parallel to the axis of rotation R of the bending carousel 110, between a spaced-apart position of non-interference with each other and a close-together position where they act in conjunction to hold the cap 2 in place on the support during bending. Preferably, the transfer carousel 120 and the bending carousel 110 are located at the same height along a direction parallel to the axis of rotation R of the bending carousel 110; after that, the support and plunger of the bending unit 111 move towards each other to allow bending the tabs 23. Once the tabs 23 of the cap 2 have been bent towards the longitudinal axis L, the cap 2 is transferred to the outfeed conveyor 16, specifically to the outfeed carousel 160 and then to the outfeed conveyor belt 161 along the outfeed path.

On the outfeed path, the recognition camera 104 captures image data representing characters moulded on the inside surface of the transverse wall 22 of the cap 2 when the cap 2 is at the fifth inspection position P4. Next, the plurality of side cameras 103 captures image data representing the side wall 21 of the cap 2 when the cap 2 is at the inspection position P5. On the outfeed path, the rejection device 13 may be controlled by the control unit to separate one or more caps 2 from the flow of caps 2 in transit through the fourth inspection position P4 along the outfeed path, based on the derived information regarding the moulded characters.

The following paragraphs, listed in alphanumeric order for reference, are non-limiting example modes of describing this invention.

A. An apparatus 1 for continuous processing of caps 2, wherein each cap 2 has a side wall 21 extending around a longitudinal axis L between a first end 211 and a second end 212, a transverse wall 22 joined to the first end 211 of the side wall 21 and a plurality of tabs 23 projecting from the second end 212 of the side wall 21, comprising:
a bending station 11, configured to bend the plurality of tabs 23 of the cap 2 towards the longitudinal axis L;
a feed unit 12, configured for moving the caps 2 along a movement path, located upstream of the bending station 11 and for feeding the caps 2 to the bending station 11, where each cap 2, along the movement path, adopts a predetermined orientation at a first inspection position P1,
a control unit, connected to one or more cameras included in the apparatus 1 to drive them synchronously with the caps 2 moving along the movement path.

A1. The apparatus 1 according to paragraph A, wherein the bending station 11 includes a bending carousel 110, rotating about an axis of rotation R, and a plurality of bending units 111, each bending unit 111 being configured to bend the plurality of tabs 23 of the cap 2 towards the longitudinal axis L.

A2. The apparatus 1 according to any one of paragraphs A to A1, wherein the feed unit 12 comprises a transfer carousel 120 located upstream of the bending station 11, the transfer carousel 120 being configured to move the cap 2 along at least one portion of the movement path in order to load the caps 2 individually into the bending station 11.

A2.1. The apparatus 1 according to paragraph A2, wherein the transfer carousel 120 is configured to load the caps 2 onto a bending carousel 110 of the bending station 11.

A2.2. The apparatus 1 according to paragraph A2 or A2.1, comprising a slide plate 14, interacting with the transfer carousel 120 to slidably support the caps 2 moved by the transfer carousel 120.

A3. The apparatus 1 according to any one of paragraphs A to A2.2, comprising an outfeed conveyor 16, configured to receive the caps 2 from the bending station 11 and to move the caps 2 along an outfeed path downstream of the bending station 11.

A4. The apparatus 1 according to any one of paragraphs A to A3, wherein the feed unit 12 includes an infeed conveyor belt 121, configured to transport the caps 2 individually in succession, along an infeed path towards the bending station 11, the infeed path forming part of the movement path.

A5. The apparatus 1 according to any one of paragraphs A to A4, comprising a cutting station 15, including a cutting carousel 150 that rotates about an axis of rotation R′ and is adapted to receive a plurality of cutting units configured to make notching on the side wall 21 of the cap 2.

A5.1. The apparatus 1 according paragraph A5, wherein a transfer carousel 120 of the feed unit 12 is located between the cutting carousel 150 and the bending carousel 110 and is configured to receive the caps 2 from the cutting carousel 150, so that a part of the movement path is defined by the movement of the cutting carousel 150, wherein the transfer carousel 120 is made according to any one of paragraphs A2 to A2.2.

A6. The apparatus 1 according to any one of paragraphs A to A5.1, comprising a first camera, located along the movement path and defining an optical axis of its own, aligned with the longitudinal axis L of the cap 2 disposed at the first inspection position P1.

A6.1. The apparatus 1 according to paragraph A6, wherein the first camera is a pericentric camera 101.

A6.1.1. The apparatus 1 according to paragraph A6.1, wherein the pericentric camera 101 comprises a biconvex lens.

A6.1.2. The apparatus 1 according to paragraph A6.1, wherein the pericentric camera 101 comprises a Fresnel lens.

A6.2. The apparatus 1 according to any one of paragraphs A6 to A6.1.2, wherein at least one portion of the movement path is defined by a transfer carousel 120 according to any one of paragraphs A2 to A2.2, wherein the first inspection position P1 is situated in said at least one portion of the movement path.

A6.3. The apparatus 1 according to any one of paragraphs A6 to A6.1.2, wherein an infeed path is defined by an infeed conveyor belt 121 according to paragraph A4 and wherein the first camera is located along the infeed path.

A6.4. The apparatus 1 according to any one of paragraphs A6 to A6.3, wherein the control unit is connected to the first camera to drive it synchronously with the caps 2 moving along the movement path.

A7. The apparatus 1 according to any one of paragraphs A to A6.4, wherein each cap 2, along the movement path, adopts a predetermined orientation at a second inspection position P2, the apparatus 1 comprising a second camera, located along the movement path and defining an optical axis of its own, aligned with the longitudinal axis L of the cap 2 at the second inspection position P2, to axially view an inside surface of the side wall 21 of the cap 2.

A7.1. The apparatus 1 according to paragraph A7, wherein the second camera is a pinhole camera 102.

A7.2. The apparatus 1 according to paragraph A7, wherein the second camera is a wide-angle camera 102.

A7.3. The apparatus 1 according to any one of paragraphs A7 to A7.2, wherein at least one portion of the movement path is defined by a transfer carousel 120 according to any one of paragraphs A2 to A2.2 and wherein the second inspection position P2 is situated in said at least one portion of the movement path.

A7.3.1. The apparatus 1 according to paragraph A7.3, comprising a slide plate 14 according to paragraph A2.2, wherein the slide plate 14 includes a black, opaque portion 141 and the second camera is directed towards the black, opaque portion 141 of the slide plate 14.

A7.4. The apparatus 1 according to any one of paragraphs A7 to A7.2, wherein an infeed path is defined by an infeed conveyor belt 121 according to paragraph A4, wherein the second camera is located along the infeed path.

A7.5. The apparatus 1 according to any one of paragraphs A7 to A7.4, wherein the control unit is connected to the second camera to drive it synchronously with the caps moving along the movement path.

A7.6. The apparatus 1 according to any one of paragraphs A7 to A7.5, wherein the control unit is connected to the second camera to receive image data from the second camera and is programmed to derive information about notching made on the side wall 21 of each cap 2.

A8. The apparatus 1 according to any one of paragraphs A to A7.6, comprising:
a third inspection position P3, where the caps 2 adopt a predetermined orientation, the third inspection position P3 being intended for receiving caps 2 provided with notching on their side walls 21, and
a plurality of side cameras 103, defining a respective plurality of optical axes oriented radially with respect to the longitudinal axis L of the cap 2 at the third inspection position P3 so as to view the outside surface of the side wall 21 of the cap 2.

A8.1. The apparatus 1 according paragraph A8, wherein at least one portion of the movement path is defined by a transfer carousel 120 according to any one of paragraphs A2 to A2.2 and wherein the third inspection position P3 is situated in said at least one portion of the movement path.

A8.2. The apparatus 1 according to paragraph A8, wherein an infeed path is defined by an infeed conveyor belt 121 according to paragraph A4, wherein the plurality of side cameras 103 is located along the infeed path.

A8.2.1. The apparatus 1 according to any one of paragraphs A8 to A8.2, wherein the control unit is connected to the plurality of side cameras 103 to drive them synchronously with the caps 2 moving along the movement path.

A8.3. The apparatus 1 according to paragraph A8, wherein an outfeed path is defined by an outfeed conveyor 16 according to paragraph A3 and wherein the third inspection position P3 is situated along the outfeed path.

A8.3.1. The apparatus 1 according to paragraph A8.3, wherein the control unit is connected to the plurality of side cameras 103 to drive it synchronously with the caps 2 moving along the outfeed path.

A8.4. The apparatus 1 according to any one of paragraphs A8 to A8.3.1, wherein the control unit is connected to the plurality of side cameras 103 to receive image data from the plurality of side cameras 103 and is programmed to derive information about notching made on the side wall 21 of each cap 2.

A9. The apparatus 1 according to any one of paragraphs A to A8.4, comprising:
a fourth inspection position P4, where the caps 2 adopt a predetermined orientation, the fourth inspection position P4 being intended for receiving caps 2 provided with characters moulded on the inside surface of the transverse wall 22, and
a recognition camera 104, defining an optical axis of its own, aligned with the longitudinal axis L of the cap 2 at the fourth inspection position P4, to image the characters moulded on the inside surface of the transverse wall 22 of the cap 2.

A9.1. The apparatus 1 according paragraph A9, wherein at least one portion of the movement path is defined by a transfer carousel 120 according to any one of paragraphs A2 to A2.2 and wherein the fourth inspection position P4 is situated in said at least one portion of the movement path.

A9.2. The apparatus 1 according to paragraph A9, wherein an infeed path is defined by an infeed conveyor belt 121 according to paragraph A4, wherein the recognition camera 104 is located along the infeed path.

A9.2.1. The apparatus 1 according to any one of paragraphs A9 to A9.2, wherein the control unit is connected to the recognition camera 104 to drive it synchronously with the caps 2 moving along the movement path.

A9.3. The apparatus 1 according to paragraph A9, wherein an outfeed path is defined by an outfeed conveyor 16 according to paragraph A3 and wherein the fourth inspection position P4 is situated along the outfeed path.

A9.3.1. The apparatus 1 according to paragraph A9.3, wherein the control unit is connected to the recognition camera 104 to drive it synchronously with the caps 2 moving along the outfeed path.

A9.4. The apparatus 1 according to any one of paragraphs A9 to A9.3.1, wherein the control unit is connected to the recognition camera 104 to receive image data and is programmed to process the image data to derive information about the characters moulded on the inside surface of the transverse wall 22 of each cap 2, thereby defining an OCR system.

A9.4.1. The apparatus 1 according to paragraph A9.4, comprising a rejection device 13, located downstream of the recognition camera 104, with respect to a feed path of the caps 2, the control unit being programmed to drive the rejection device 13 so as to separate one or more caps 2 from the flow of caps 2 in transit through the fourth inspection position P4 based on the derived information regarding the moulded characters.

A10. The apparatus 1 according to any one of paragraphs A to A9.4.1, wherein each cap 2, along the movement path, adopts a predetermined orientation at a fifth inspection position P5, the apparatus 1 comprising a fixed focal length camera 105, located along the movement path and defining an optical axis of its own, aligned with the longitudinal axis L of the cap at the fifth inspection position P5, to view an outside surface of the transverse wall 22 of the cap 2.

A10.1. The apparatus 1 according paragraph A10, wherein a portion of the movement path is defined by a transfer carousel 120 according to any one of paragraphs A2 to A2.2 and wherein the fifth inspection position P5 is situated in said portion of the movement path.

A10.1.1. The apparatus 1 according to paragraph A10.1, comprising a slide plate 14 according to paragraph A2.2, wherein the slide plate 14 includes a transparent portion 143 and the fixed focal length camera 105 is directed towards the transparent portion 143 of the slide plate 14.

A10.2. The apparatus 1 according to any one of paragraphs A10 to A10.1.1, wherein the control unit is connected to the fixed focal length camera 105 to drive it synchronously with the caps 2 moving along the movement path.

A10.3. The apparatus 1 according to any one of paragraphs A10 to A10.2, wherein the control unit is connected to the fixed focal length camera 105 to receive image data from the fixed focal length camera 105 and is programmed to derive an image representing the transverse wall 22 of the cap 2.

A11. The apparatus 1 according to any of the paragraphs from A to A10.3, wherein:
the bending station 11 includes a bending carousel 110, rotating about an axis of rotation R, and a plurality of bending units 111, each bending unit 111 being configured to bend the plurality of tabs 23 of the cap 2 towards the longitudinal axis L;
the feed unit 12 comprises a transfer carousel 120 located upstream of the bending station 11, the transfer carousel 120 being configured to move the cap 2 along at least one portion of the movement path in order to load

### The Caps 2 Individually Onto the Bending Carousel 110 of the Bending

station 11;
the feed unit 12 includes an infeed conveyor belt 121, configured to transport the caps 2 individually in succession, along an infeed path towards the bending station 11, the infeed path forming part of the movement path,
   the apparatus 1 comprising:
an outfeed conveyor 16, configured to receive the caps 2 from the bending station 11 and to move the caps 2 along an outfeed path downstream of the bending station 11;
a cutting station 15, including a cutting carousel 150 that rotates about an axis of rotation R′ and is adapted to receive a plurality of cutting units configured to make notching on the side wall 21 of the cap 2, wherein the transfer carousel 120 of the feed unit 12 is located between the cutting carousel 150 and the bending carousel 111 and is configured to receive the caps 2 from the cutting carousel 150, so that a part of the movement path is defined by the movement of the cutting carousel 150.

A11.1. The apparatus 1 according to paragraph A11, comprising:
a first camera according to any one of paragraphs A6 to A6.4, located along the movement path and defining an optical axis of its own, aligned with the longitudinal axis L of the cap 2 disposed at the first inspection position P1, wherein the first inspection position P1 is situated in the aforesaid at least one portion of the movement path;
a second camera according to any one of paragraphs A7 to A7.6, located along the movement path and defining an optical axis of its own, aligned with the longitudinal axis L of the cap 2 at a second inspection position P2, wherein, at the second inspection position P2, each cap 2 adopts a predetermined orientation and wherein the second inspection position P2 is situated in the aforesaid at least one portion of the movement path;
a third inspection position P3, where the caps 2 adopt a predetermined orientation, the third inspection position P3 being intended for receiving caps 2 provided with notching on their side walls 21;
a plurality of side cameras 103 according to any one of paragraphs A8 to A8.4, defining a respective plurality of optical axes oriented radially with respect to the longitudinal axis L of the cap 2 at the third inspection position P3 to view the outside surface of the side wall 21 of the cap 2, wherein the third inspection position P3 is situated along the outfeed path;
a fourth inspection position P4, where the caps 2 adopt a predetermined orientation, the fourth inspection position P4 being intended for receiving caps 2 provided with characters moulded on the inside surface of the transverse wall 22;
a recognition camera 104 according to any one of paragraphs A9 to A9.4.1, defining an optical axis of its own, aligned with the longitudinal axis L of the cap 2 at the fourth inspection position P4, to image characters moulded on the inside surface of the transverse wall 22 of the cap 2, wherein the fourth inspection position P4 is situated along the outfeed path;
a fixed focal length camera 105 according to any one of paragraphs A10 to A10.3, located along the movement path and defining an optical axis of its own, aligned with the longitudinal axis L of the cap 2 at a fifth inspection position P5, to view an outside surface of the transverse wall 22 of the cap 2, wherein, at the fifth inspection position P5, each cap 2 adopts a predetermined orientation and wherein the fifth inspection position P5 is situated in the aforesaid at least one portion of the movement path.

B. A method for continuous processing of caps, each cap 2 having a side wall 21 extending around a longitudinal axis L between a first end 211 and a second end 212, a transverse wall 22 joined to the first end 211 of the side wall 21 and a plurality of tabs 23 projecting from the second end 212 of the side wall 21, the method comprising the following steps:
by means of a bending station 11, bending the plurality of tabs 23 of the caps 2 towards the longitudinal axis L;
through a feed unit 12, moving the caps 2 along a movement path, located upstream of the bending station 11 and feeding the caps 2 to the bending station 11, wherein each cap 2, along the movement path, adopts a predetermined orientation at a first inspection position P1;
through a control unit, driving one or more cameras included in the apparatus 1 synchronously with the caps 2 moving along the movement path.

B1. The method according to paragraph B, wherein the bending station 11 includes a bending carousel 110, rotating about an axis of rotation R, and a plurality of bending units 111 associated with the bending station 11.

B2. The method according to paragraph B or B1, wherein the feed unit 12 includes a transfer carousel 120, located upstream of the bending station 11, the method comprising the following steps, performed by the transfer carousel 120:
moving the caps 2 along at least one portion of the movement path, and
loading the caps 2 individually into the bending station 11.

B2.1. The method according to paragraph B2, wherein the transfer carousel 120 loads the caps 2 individually onto a bending carousel 110 of the bending station 11.

B3. Method according to any one of paragraphs B to B2.1, comprising a step of capturing image data by means of a first camera, located along the movement path and defining an optical axis of its own, aligned with the longitudinal axis L of the cap 2 when the cap 2 is at the first inspection position P1.

B3.1. The method according to paragraph B3, wherein the first camera is a pericentric camera 101.

B3.1.1. The method according to paragraph B3.1, wherein the pericentric camera 101 comprises a biconvex lens.

B3.1.2. The method according to paragraph B3.1, wherein the pericentric camera 101 comprises a Fresnel lens.

B3.2. The method according to any one of paragraphs B3 to B3.1.2, wherein at least one portion of the movement path is defined by a transfer carousel 120 according to any one of paragraphs B2 to B2.1, wherein the first inspection position P1 is situated in said at least one portion of the movement path and the first camera is stationary relative to the transfer carousel 120.

B3.3. The method according to any one of paragraphs B3 to B3.2, comprising a step, performed by the control unit, of driving the first camera synchronously with the caps 2 moving along the movement path.

B4. The method according to any one of paragraphs B to B3.3, comprising a step of capturing image data by means of a second camera, located along the movement path and defining an optical axis of its own, aligned with the longitudinal axis L of the cap 2 when the cap 2 is at a second inspection position P2, wherein, at the second inspection position P2, the cap adopts a predetermined orientation.

B4.1. The method according to paragraph B4, wherein the second camera is a pinhole camera 102.

B4.2. The method according to paragraph B4, wherein the second camera is a wide-angle camera.

B4.3. The method according to any one of paragraphs B4 to B4.2, wherein at least one portion of the movement path is defined by a movement of a transfer carousel 120 according to any one of paragraphs B2 to B2.1 and wherein the second inspection position P2 is situated in said at least one portion of the movement path.

B4.4. The method according to any one of paragraphs B4 to B4.3, comprising a step, performed by the control unit, of receiving the image data from the second camera and a step of processing the image data received to derive information about notching on the side wall 21 of each cap 2.

B5. The method according to any one of paragraphs B to B4.4, comprising the following steps:
at a third inspection position P3, receiving a flow of caps 2 provided with notching on their side walls 21, wherein the caps 2, at the third inspection position P3, adopt a predetermined orientation;
capturing image data by means of a plurality of side cameras 103, defining a respective plurality of optical axes oriented radially with respect to the longitudinal axis L of the cap 2 when the cap 2 is at the third inspection position P3, so as to view the outside surface of the side wall 21 of the cap 2.

B5.1. The method according to paragraph B5, comprising a step, performed by the control unit, of receiving the image data from the plurality of side cameras 103 and a step of processing the image data received to derive information about the notching on the side wall 21 of each cap 2.

B6. The method according to any one of paragraphs B to B5, comprising the following steps:
at a fourth inspection position P4, receiving a flow of caps 2 provided with characters moulded on the inside surface of the transverse wall 22, wherein the caps 2, at the fourth inspection position P4, adopt a predetermined orientation;
capturing image data by means of a recognition camera 104, defining an optical axis of its own, aligned with the longitudinal axis L of the cap 2 when the cap 2 is at the fourth inspection position P4, to image the characters moulded on the inside surface of the transverse wall 22 of the cap 2.

B6.1. The method according to paragraph B6, comprising the following steps, performed by the control unit:
receiving image data from the recognition camera 104;
processing the image data to derive information regarding the characters moulded on the inside surface of the transverse wall 22 of the cap 2, thus defining an OCR system.

B6.1.1. The method according to paragraph B6.1, comprising a step, performed by the control unit, of driving a rejection device 13, located downstream of the recognition camera 104, with respect to a feed path of the caps 2, so as to separate one or more caps 2 from the flow of caps 2 in transit through the fourth inspection position P4 based on the derived information regarding the moulded characters.

B7. The method according to any one of paragraphs B to B6.1.1, comprising the following steps:
providing a fifth inspection position P5 along the movement path, the caps 2 adopting a predetermined orientation at the fifth inspection position P5;
along the movement path, providing a fixed focal length camera 105 defining an optical axis of its own, aligned with the longitudinal axis L when the cap 2 is at the fifth inspection position P5.

B7.1. The method according to paragraph B7, wherein at least one portion of the movement path is defined by a movement of a transfer carousel 120 according to any one of paragraphs B2 to B2.1 and wherein the fifth inspection position P5 is situated in said at least one portion of the movement path.

B7.2. The method according to any one of paragraphs B7 to B7.1, comprising the following steps, performed by the control unit:
receiving the image data from the fixed focal length camera 105;
processing the image data to derive an image representing the transverse wall 22 of the cap 2.

B8. The method according to any one of paragraphs B to B7.1, wherein:
the bending station 11 includes a bending carousel 110, rotating about an axis of rotation R, and a plurality of bending units 111, each bending unit 111 being configured to bend the plurality of tabs 23 of the cap 2 towards the longitudinal axis L;
the feed unit 12 comprises a transfer carousel 120 located upstream of the bending station 11, the transfer carousel 120 being configured to move the cap 2 along at least one portion of the movement path in order to load the caps 2 individually onto the bending carousel 110 of the bending station 11;
the feed unit 12 includes an infeed conveyor belt 121, configured to transport the caps 2 individually in succession, along an infeed path towards the bending station 11, the infeed path forming part of the movement path, the method comprising the following steps:
through an outfeed conveyor 16, receiving the caps 2 from the bending station 11 and moving the caps 2 along an outfeed path downstream of the bending station 11;
providing a cutting station 15, including a cutting carousel 150 that rotates about an axis of rotation R′ and is adapted to receive a plurality of cutting units configured to make notching on the side wall 21 of the cap 2, wherein the transfer carousel 120 of the feed unit 12 is located between the cutting carousel 150 and the bending carousel 110; through the transfer carousel 120, receiving caps 2 from the cutting carousel 150 so that a part of the movement path is defined by the movement of the cutting carousel 150.

B8.1. The method according to paragraph B8, comprising the following steps:
capturing image data by means of a first camera according to any one of paragraphs B3 to B3.3, located along the movement path and defining an optical axis of its own, aligned with the longitudinal axis L of the cap 2 when the cap 2 is at the first inspection position P1;
at a second inspection position P2, receiving a flow of caps 2 provided with notching on their side walls 21, wherein the caps 2, at the second inspection position P2, adopt a predetermined orientation;
providing a second camera according to any one of paragraphs B4 to B4.4, defining an optical axis of its own, aligned with the longitudinal axis L of the cap 2 when the cap 2 is at the second inspection position P2, and capturing image data through the second camera;
at a third inspection position P3, receiving a flow of caps 2 provided with notching on their side walls 21, wherein the caps 2, at the third inspection position P3, adopt a predetermined orientation;
capturing image data by means of a plurality of side cameras 103 according to any one of paragraphs B5 to B5.1, defining a respective plurality of optical axes oriented radially with respect to the longitudinal axis L of the cap 2 when the cap 2 is at the third inspection position P3, so as to view the outside surface of the side wall 21 of the cap 2, and
at a fourth inspection position P4, receiving a flow of caps 2 provided with characters moulded on the inside surface of the transverse wall 22, wherein the caps 2, at the fourth inspection position P4, adopt a predetermined orientation;
capturing image data by means of a recognition camera 104 according to any one of paragraphs B6 to B6.1.1, defining an optical axis of its own, aligned with the longitudinal axis L of the cap 2 when the cap 2 is at the fourth inspection position P4, to image the characters moulded on the inside surface of the transverse wall 22 of the cap 2;
at a fifth inspection position P5, receiving caps 2, wherein the caps 2, at the fifth inspection position P5, adopt a predetermined orientation;
capturing image data by means of a fixed focal length camera 105 according to any one of paragraphs B7 to B7.2, defining an optical axis of its own, aligned with the longitudinal axis L of the cap 2 when the cap 2 is at the fifth inspection position P5, to image the characters moulded on the inside surface of the transverse wall 22 of the cap 2.

1. An apparatus for continuous processing of caps, wherein each cap has a side wall extending around a longitudinal axis between a first end and a second end, a transverse wall joined to the first end of the side wall and a plurality of tabs projecting from the second end of the side wall, comprising:
a bending station including a bending carousel, rotating about an axis of rotation, and a plurality of bending units, each bending unit being configured to bend the plurality of tabs of the cap towards the longitudinal axis;
a feed unit, configured for moving the caps along a movement path, located upstream of the bending station ) and for feeding the caps to the bending station, where each cap, along the movement path, adopts a predetermined orientation at a first inspection position;
a pericentric camera located along the movement path and defining an optical axis of its own, aligned with the longitudinal axis of the cap disposed at the first inspection position;
a control unit, connected to the pericentric camera to drive it synchronously with the caps moving along the movement path.

2. The apparatus according to claim 1, wherein each cap, along the movement path, adopts a predetermined orientation at a second inspection position, the apparatus comprising a pinhole or wide-angle camera, located along the movement path and defining an optical axis of its own, aligned with the longitudinal axis of the cap at the second inspection position, to axially view an inside surface of the side wall of the cap.

3. The apparatus according to claim 2, comprising:
a third inspection position, where the caps adopt a predetermined orientation, the third inspection position being intended for receiving caps provided with notching on their side walls, and
a plurality of side cameras, defining a respective plurality of optical axes oriented radially with respect to the longitudinal axis of the cap at the third inspection position so as to view the outside surface of the side wall of the cap,
wherein the control unit is connected to the pinhole or wide-angle camera and to the plurality of side cameras to receive respective image data and is programmed to process the image data in order to derive information regarding the notching of the side wall of each cap.

4. The apparatus according to claim 1, comprising:
a fourth inspection position, where the caps adopt a predetermined orientation, the fourth inspection position being intended for receiving caps provided with characters moulded on the inside surface of the transverse wall,
a recognition camera, defining an optical axis of its own, aligned with the longitudinal axis of the cap at the fourth inspection position, to image the characters moulded on the inside surface of the transverse wall of the cap, and
a rejection device, located downstream of the recognition camera with respect to a feed path of the caps,
wherein the control unit is connected to the recognition camera to receive image data and is programmed to process the image data to derive information about the characters moulded on the inside surface of the transverse wall of each cap, thereby defining an OCR system, the control unit being programmed to drive the rejection device so as to separate one or more caps from the flow of caps in transit through the fourth inspection position based on the derived information regarding the moulded characters.

5. The apparatus according to claim 1, wherein:
the feed unit comprises a transfer carousel located upstream of the bending station, the transfer carousel being configured to move the cap along at least one portion of the movement path in order to load the caps individually onto the bending carousel of the bending station
the first inspection position is located in said at least one portion of the movement path, the pericentric camera being stationary relative to the transfer carousel.

6. The apparatus according to claim 5, comprising a slide plate that interacts with the transfer carousel to slidably support the caps moved by the transfer carousel, wherein the slide plate includes a black, opaque portion and the pericentric camera is directed towards the black, opaque portion of the slide plate

7. The apparatus according to claim 5, wherein
each cap, along the movement path, adopts a predetermined orientation at a fifth inspection position, the apparatus comprising a fixed focal length camera, located along the movement path and defining an optical axis of its own, aligned with the longitudinal axis of the cap at the fifth inspection position, to view an outside surface of the transverse wall of the cap;
the fifth inspection position is located in said at least one portion of the movement path;
the transfer carousel includes a first face and a second face, opposite the first face, the pericentric camera being directed towards the first face and the fixed focal length camera being directed towards the second face.

8. The apparatus according 5, wherein each cap, along the movement path, adopts a predetermined orientation at a second inspection position, the apparatus comprising a pinhole or a wide-angle camera, located along the movement path and defining an optical axis of its own, aligned with the longitudinal axis of the cap at the second inspection position, wherein the second inspection position is situated in said at least one portion of the movement path, the pinhole or wide-angle camera being stationary relative to the transfer carousel, wherein the transfer carousel includes a first face and a second face, opposite the first face, both the pericentric camera and the pinhole or wide-angle camera being directed at the first face.

9. The apparatus according to claim 5, comprising a cutting station, including a cutting carousel that rotates about an axis of rotation and is adapted to receive a plurality of cutting units configured to make notching on the side wall of the cap, wherein the transfer carousel is located between the cutting carousel and the bending carousel and is configured to receive the caps from the cutting carousel, so that a part of the movement path is defined by the movement of the cutting carousel.

10. The apparatus according to claim 1, comprising:
an outfeed conveyor, configured to receive the caps from the bending station and to move the caps along an outfeed path downstream of the bending station;
a third inspection position, where the caps adopt a predetermined orientation, the third inspection position being intended for receiving caps provided with notching on their side walls;
a plurality of side cameras, defining a respective plurality of optical axes oriented radially with respect to the longitudinal axis of the cap at the third inspection position so as to view the outside surface of the side wall of the cap,
wherein the third inspection position is situated along the outfeed path.

11. The apparatus according to claim 1, wherein the feed unit includes an infeed conveyor belt configured to transport the caps individually in succession, along an infeed path towards the bending station, the infeed path forming part of the movement path, wherein one or more of the following conditions is true:
i) the pericentric camera is located along the infeed path;
ii) the apparatus comprises a pinhole or wide-angle camera, the pinhole or wide-angle camera being located along the infeed path;
iii) the apparatus (1) comprises a plurality of side cameras the plurality of side cameras being located along the infeed path;
iv) the apparatus comprises a recognition camera the recognition camera (104) being located along the infeed path.

12. The apparatus according to claim 1, wherein the control unit is programmed to process image data captured by the pericentric camera and to compare them with reference data representing a correct positioning of the plurality of tabs in order to derive an alert signal responsive to a negative result of the comparison.

13. A method for continuous processing of caps, each cap having a side wall extending around a longitudinal axis between a first end and a second end, a transverse wall joined to the first end of the side wall and a plurality of tabs projecting from the second end of the side wall, the method comprising the following steps:
bending the plurality of tabs of the caps towards the longitudinal axis by means of a bending station including a bending carousel, rotating about an axis of rotation, and a plurality of bending units associated with the bending station;
through a feed unit moving the caps along a movement path, located upstream of the bending station and feeding the caps to the bending station, wherein each cap, along the movement path, adopts a predetermined orientation at a first inspection position;
capturing image data by means of a pericentric camera, located along the movement path and defining an optical axis of its own, aligned with the longitudinal axis of the cap when the cap is at the first inspection position
through a control unit, driving the pericentric camera synchronously with the caps moving along the movement path.

14. The method according to claim 13, comprising the following steps:
capturing image data by means of a pinhole or wide-angle camera, located along the movement path and defining an optical axis of its own, aligned with the longitudinal axis of the cap when the cap is at a second inspection position, wherein, at the second inspection position, the cap adopts a predetermined orientation;
at a third inspection position, receiving a flow of caps provided with notching on their side walls, wherein the caps, at the third inspection position, adopt a predetermined orientation;
capturing image data by means of a plurality of side cameras, defining a respective plurality of optical axes oriented radially with respect to the longitudinal axis of the cap when the cap is at the third inspection position, so as to view the outside surface of the side wall of the cap, and
through the control unit, receiving the image data from the pinhole or wide-angle camera and the image data from the plurality of side cameras, and processing the image data received in order to derive information regarding the notching on the side wall of each cap.

15. The method according to claim 14, wherein the feed unit includes a transfer carousel, located upstream of the bending station the method comprising the following steps, performed by the transfer carousel.
moving the caps along at least one portion of the movement path, and
loading the caps individually onto the bending carousel of the bending station.
wherein the first inspection position is located in said at least one portion of the movement path, the pericentric camera being stationary relative to the transfer carousel.

16. The method according to claim 15, comprising the following steps:
providing a second inspection position along the movement path, the caps adopting a predetermined orientation at the second inspection position;
providing a pinhole or wide-angle camera defining an optical axis of its own, aligned with the longitudinal axis of the cap when the cap is at the second inspection position;
providing a fifth inspection position along the movement path, the caps adopting a predetermined orientation at the fifth inspection position;
along the movement path, providing a fixed focal length camera defining an optical axis of its own, aligned with the longitudinal axis when the cap is at the fifth inspection position;
wherein the second inspection position and the fifth inspection position are situated in said at least one portion of the movement path defined by the transfer carousel.

17. The apparatus according to claim 5, comprising one or more of the following:
a pinhole camera or wide-angle camera, to axially view an inside surface of the side wall of the cap;
a plurality of side cameras, to view the outside surface of the side wall of the cap, and
a fixed focal length camera, to view an outside surface of the transverse wall of the cap,
located in the transfer carousel.

18. The apparatus according to claim 17, wherein with respect to a straight line joining the axis of rotation of the bending carousel with the axis of rotation of the cutting carousel and dividing the plane in an upper half-plane and in a lower half-plane, one or more of the pericentric camera, the pinhole camera, the plurality of side cameras and the fixed focal length camera are located in the same half-plane.

19. The apparatus according to claim 18, wherein the axis of rotation of the transfer carousel is located in the same half-plane of the one or more of the pericentric camera, the pinhole camera, the plurality of side cameras and the fixed focal length camera.

20. The apparatus according to claim 19, wherein the feed unit includes an infeed conveyor belt, configured to transport the caps individually in succession, along an infeed path towards the bending station, the one or more of the pericentric camera, the pinhole camera, the plurality of side cameras and the fixed focal length camera being located in the same half-plane of the infeed conveyor belt.
